(19) United States
(12) Patent Application Publication
(10) Pub. No.: US 2006/0098615 A1
(43) Pub. Date: May 11, 2006

(54) Controlling a use of automated content

(75) Inventor: Timo Vataja, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/255,773

(22) Filed: Oct. 21, 2005

(30) Foreign Application Priority Data
Oct. 22, 2004 (WO) PCT/IB04/03471

(51) Int. Cl. H04Q 7/24

(52) U.S. Cl. 370/338

(57) ABSTRACT

Control of the use of automated content at a wireless communication terminal 10 able to access a wireless communication network 20 is shown. In order to enable a flexible control of the use of automated content, the network detects a terminal 10 accessing the network 20 and transmitting an indication to the terminal 10 indicating that the network 20 allows using exclusively Digital Rights Management (DRM) protected automated content. The terminal 10 receives such an indication from the network 20 and stores the indication in a storage 12. The stored indication may then be used for deciding whether a content selected by a user of the terminal 10 is allowed to be used as an automated content.

### FIELD OF THE INVENTION

The invention relates to methods for controlling a use of automated content at a wireless communication terminal, which wireless communication terminal is able to access a wireless communication network. The invention relates equally to corresponding processing modules, a corresponding network element of a wireless communication network, a corresponding wireless communication terminal, corresponding software codes and software program products and a corresponding wireless communication system.

### BACKGROUND OF THE INVENTION

Wireless communication terminals generally comprise some kind of automated content. Automated content is content which is used in the terminal in an automatic way. An automated content may be for instance a ringing tone, which is played automatically in case of an incoming call, a background image which is presented automatically when the terminal is in an active state, a skin or theme which is applied automatically to a menu, etc.

Typically, a user of a wireless communication terminal is enabled to download a desired content to the terminal, to store the content in the terminal in the form of a data file, and to select this content for use as an automated content, if desired.

Some content, which can be used as an automated content is protected by a digital right management (DRM). Such DRM protected content is offered for instance by operators of wireless communication networks or by content providers for a charge. Measures are taken that such DRM protected content cannot be freely duplicated.

Other content that can be used as an automated content, however, is not DRM protected. Such content can often be downloaded for free into the wireless communication terminal, for example in form of MP3, MIDI or gif files via the Internet.

As a result, fewer and fewer users buy content from network operators or content providers.

In order to ensure that only DRM protected content can be selected as an automated content, the manufacturers of the wireless communication terminals could hard-code this requirement into the software of the terminals.

This would be a rather inflexible approach, though.

### SUMMARY OF THE INVENTION

It is an object of the invention to enable a flexible control of the use of automated content in a wireless communication terminal.

For a network side, a method is proposed for controlling a use of automated content at a wireless communication terminal, which wireless communication terminal is able to access a wireless communication network. The method comprises at the wireless communication network detecting a wireless communication terminal accessing the wireless communication network. Further, the method comprises transmitting an indication to the wireless communication terminal indicating that the wireless communication network allows the wireless communication terminal to use exclusively automated content which is protected by a digital rights management.

For a network side, moreover a processing module for a network element of a wireless communication network is proposed. The wireless communication network can be accessed by a wireless communication terminal. The processing module is adapted to receive information that a wireless communication terminal is accessing the communication network and to cause a transmission of an indication to the wireless communication terminal indicating that the wireless communication network allows the wireless communication terminal to use exclusively automated content which is protected by a digital rights management.

For a network side, moreover a network element for a wireless communication network is proposed, which comprises the proposed processing module for a network element.

For a network side, moreover an automated content control software code for controlling a use of automated content at a wireless communication terminal is proposed. The wireless communication terminal is able to access a wireless communication network. When running in a processing module of a network element of the wireless communication network, the automated content control software code detects a wireless communication terminal accessing the wireless communication network. Further, the software code transmits an indication to the wireless communication terminal indicating that the wireless communication network allows the wireless communication terminal to use exclusively automated content, which is protected by a digital rights management.

For a network side, finally a software program product is proposed which stores the proposed automated content control software code.

For a terminal side, as well, a method is proposed for controlling a use of automated content at a wireless communication terminal, which wireless communication terminal is able to access a wireless communication network. This method comprises at the wireless communication terminal receiving from the wireless communication network an indication indicating whether the communication network allows the wireless communication terminal to use exclusively automated content which is protected by a digital rights management. The method further comprises storing the indication in storage.

For a terminal side, moreover a processing module for a wireless communication terminal, which is able to access a wireless communication network, is proposed. The processing module is adapted to receive from the wireless communication network an indication indicating whether the wireless communication network allows the wireless communication terminal to use exclusively automated content, which is protected by a digital rights management. The processing module is further adapted to store a received indication indicating whether the wireless communication network allows the wireless communication terminal to use exclusively automated content which is protected by a digital rights management in a storage of the wireless communication terminal.

For a terminal side, moreover a wireless communication terminal is proposed, which is able to access a wireless communication network and which comprises the proposed processing module for a wireless communication terminal.

For a terminal side, moreover a digital rights management software code is proposed for controlling a use of automated content at a wireless communication terminal.

The wireless communication terminal is able to access a wireless communication network. When running in a processing module of the wireless communication terminal, the automated content control software code receives from the wireless communication network an indication indicating whether the wireless communication network allows the wireless communication terminal to use exclusively automated content which is protected by a digital rights management. The software code further stores this indication in storage.

For a terminal side, further a software program product is proposed which stores the proposed digital rights management software code.

Finally, a wireless communication system is proposed, which comprises at least one proposed network element and at least one proposed wireless communication terminal.

The invention proceeds from the consideration that the operator of a wireless communication network could be enabled to define whether only DRM protected content shall be selected by a user of a wireless communication terminal as an automated content. It is therefore proposed that a wireless communication network, which detects a roaming wireless communication terminal, transmits a corresponding indication to the wireless communication terminal. The wireless communication terminal receives and stores this indication as a basis for deciding on later content selections by a user.

It is an advantage of the invention that it allows network operators to control their content business by dynamically enabling or disabling the use of free content as an automated content. The same terminal may thus be granted different rights by different networks it accesses. The control does not even have to be uniform for all terminals accessing a single network. It could also be made dependent, for example, on the contract of a user of the respective terminal.

It is further an advantage of the invention that a hard-coded solution by the terminal manufacturers can be avoided. In addition to the achieved flexibility, this implies that it is not necessary to adapt the wireless communication terminals in the manufacturing phase to specific operators, which reduces the costs of the wireless communication terminals.

The controlled automated content may comprise any type of automated content, for instance a ringing tone, a background image, a wallpaper and a skin, etc., or a combination of two or more of them in form of a theme.

The indication transmitted by the network and received at a terminal may be a dedicated signal or be included as a parameter in an existing signal. The indication may be for instance simply a flag, which is set or not.

The indication does not have to indicate necessarily for all possible types of automated content that only DRM protected content is allowed to be used. It may also indicate only for selected types of automated content that only DRM protected content is allowed to be used.

Further, separate indications might be provided for different types of automated content. In this case, the control is particularly flexible.

It is to be understood that if the network does not wish to prevent the use of free automated content, it can either transmit a corresponding indication, which is then stored by the terminal as well, or not transmit any indication at all.

In order to ensure in the latter case that the user of the terminal may select free content as well as an automated content when changing from a network, which allows only the use of DRM protected content, further measures should be provided at the terminal.

In one embodiment of the invention, a terminal detecting that it is accessing a new wireless communication network first stores an indication in the storage indicating that the accessed wireless communication network allows using any kind of automated content. Thereby, it is ensured that also free content can be selected as an automated content, if the currently accessed network does not provide any indication.

The storage in the terminal is advantageously protected from unauthorized accesses. It may be a secure place of the terminal, at which the user of the terminal cannot easily tamper or change any stored information. This can be achieved for example by realizing the access to the storage via a manufacturer specific operating system.

Once the indication is stored, it may be used in the terminal as a basis for deciding about content selections by a user.

One embodiment of the invention is provided for the case that a user of the wireless communication terminal selects content for use as an automated content. In this embodiment, a use of the content as an automated content is prevented, if the content is determined not to be DRM protected and the indication stored in the storage indicates that the wireless communication network allows the wireless communication terminal to use exclusively DRM protected automated content.

In a further embodiment of the invention, a user of the wireless communication terminal is informed in case a requested use of a selected content as an automated content is prevented.

The invention can be used in any type of wireless communication system, for instance for a cellular communication system and/or a wireless local area network (WLAN) based communication system.

### BRIEF DESCRIPTION OF THE FIGURES

Other objects and features of the present invention will become apparent from the following detailed description considered in conjunction with the accompanying drawings.

FIG. 1 is a schematic block diagram of a communication system according to an embodiment of the invention;

FIG. 2 is a flow chart illustrating an operation in the system of FIG. 1; and

FIG. 3 is a flow chart illustrating an operation in a mobile terminal of the system of FIG. 1.

### DETAILED DESCRIPTION OF THE INVENTION

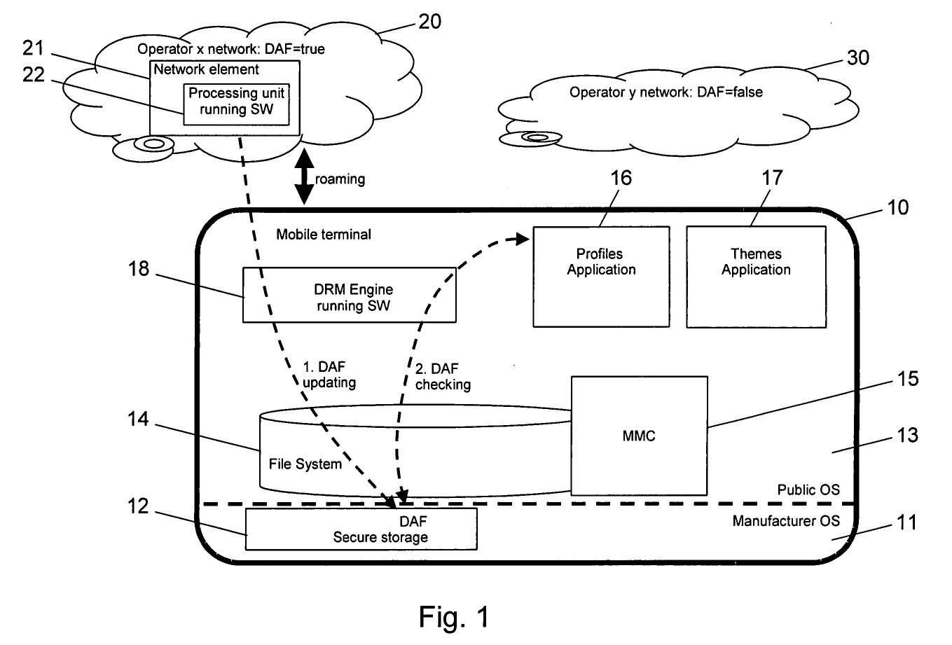

FIG. 1 is a schematic block diagram of a communication system according to an embodiment of the invention, which enables a flexible handling of automated content.

The system comprises a wireless communication terminal 10 and a network element 21 of a wireless communication network 20 operated by a first operator x. In addition, a further wireless communication network 30 operated by a second operator y is indicated. The wireless communication networks 20, 30 are assumed by way of example to be mobile communication networks and the wireless communication terminal 10 is assumed by way of example to be a mobile terminal, like a mobile phone.

The operator x of network 20 sells DRM protected content and is therefore interested in that mobile terminals accessing the network 20 are only able to use DRM protected content as an automated content. The network element 21 of the communication network comprises a processing unit 22. The processing unit 22 forms a processing module for a network element according to an embodiment of the invention and runs automated content control software according to an embodiment of the invention.

The operator y of network 30 is not interested in preventing mobile terminals, which are accessing the network 30, from using also free content as an automated content.

The mobile terminal 10 comprises a first portion 11, which is based on a manufacturer specific operating system OS. This portion 11 includes a secure storage 12 storing a DRM automated flag DAF, which can be set to “true” or “false”. It is to be understood that the operating system for this first portion 11 is not required to be manufacturer specific as in the presented exemplary embodiment; it only has to ensure that the first portion 11 is a safe storing place. That is, it has to be efficiently prevented that the end-user can change the value of the flag and that any user-installed application can override or manipulate the flag.

The mobile terminal 10 further comprises a second portion 13, which is based on a public operating system OS, like SymbianOS.

The second portion 13 includes a file system 14 managing the access to a general memory of the mobile terminal 10. In addition, the file system 14 enables the access to the secure storage 12 and to a multimedia card MMC 15 which may be connected to the mobile terminal 10. Such a MMC 15 may store any type of content, including DRM protected content. It is to be understood that instead of the multimedia card 15, a Secure Digital (SD) memory card or any other removable memory card could be utilized as well for storing the content. Further, the content could also be stored in a memory of the mobile terminal itself, not to a memory card.

The second portion 13 moreover includes a profiles application 16 and a themes application 17. The profiles application 16 and the themes application 17 both enable a user to select an automated content, which is to be used via a user interface (not shown). The profiles application 16 enables a separate selection of automated content for a respective single type of use, for instance for a default ringing tone or for a background image. The themes application 17 enables a selection of a comprehensive automated content which is associated to a specific theme, combining for instance files for a ringing tone, for a background image, for switching on and off animation, etc.

The second portion 13 moreover includes a DRM engine 18. The DRM engine 18 forms a processing module according to an embodiment of the invention. Digital rights management software according to an embodiment of the invention run by the DRM engine 18 realizes the functions of the DRM engine 18. Only the DRM engine 18 is able to access the secure storage 12 via the file system 14 and to allow or reject setting a particular stored content as an automated content.

It is to be understood that the mobile terminal 10 comprises a plurality of further components which are not depicted in FIG. 1, but which are known to be used in mobile terminals.

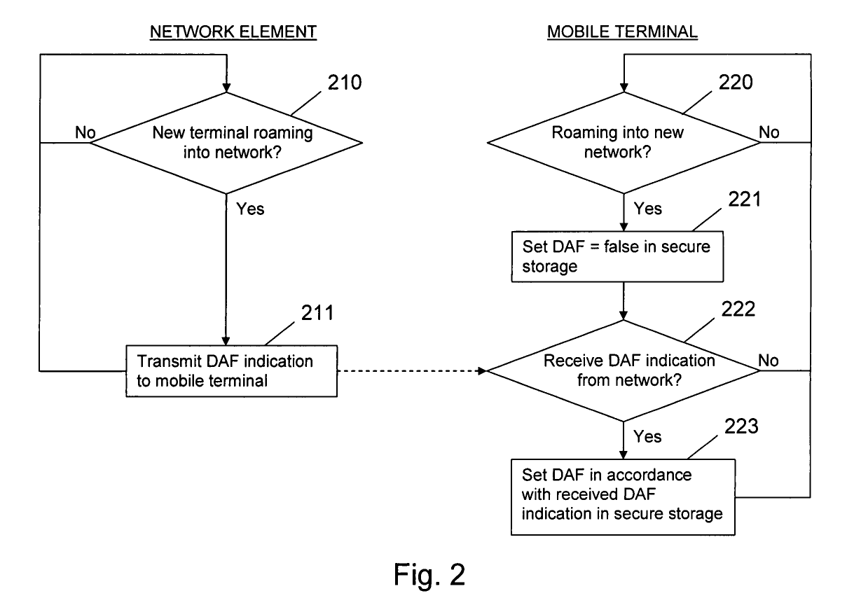

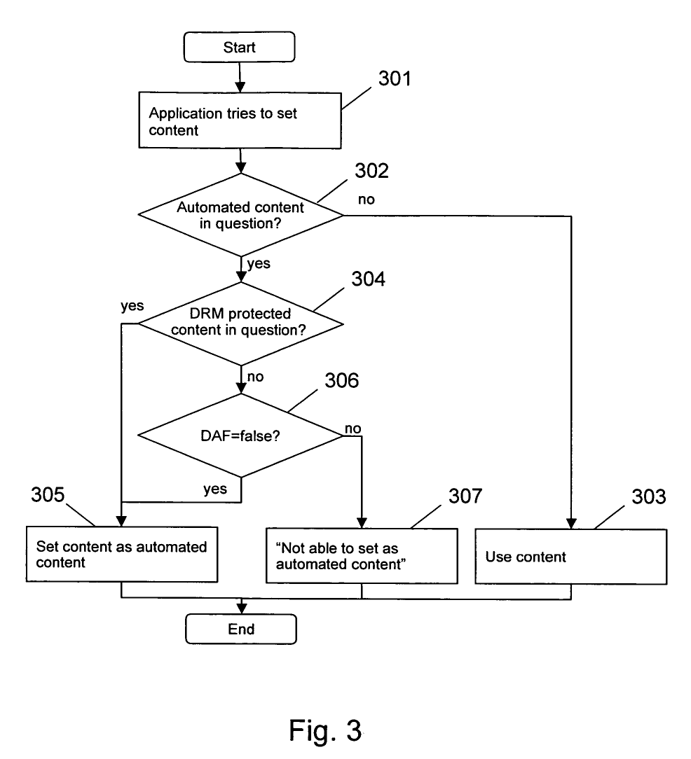

An operation in the system will now be described with reference to FIGS. 2 and 3.

FIG. 2 is a flow chart illustrating the flexible control of the automated content handling by a network operator.

As a starting point, the mobile terminal 10 is assumed to be accessing a specific network, for example the network 30 of operator y. If the operator of this network allows mobile terminals using only DRM protected automated content, the DAF in the secure storage 12 of the mobile terminal 10 is set to “true”. Otherwise, the DAF in the secure storage 12 is set to “false”, as in the case of an access to the network 30 of operator y.

The DRM engine 18 of the mobile terminal 10 monitors whether the mobile terminal 10 is roaming into another network or the DRM engine receives the information considering roaming into another network from some other software or hardware component (step 220).

If the DRM engine 18 detects that the mobile terminal 10 is roaming into another network, for instance the network 20 of operator x, it sets the DAF in the secure storage 12 to “false” (step 220).

In parallel, the network 20 of operator x registers that a new mobile terminal 10 is accessing the network 20. This information is provided to the processing unit 22 of network element 21 of the network 20. The network element 21 can be for example the base station via which the mobile terminal 10 accesses the network 20 or a network element associated to this base station.

When the automated content control software run by the processing unit 22 receives information that a new mobile terminal 10 is roaming into the network 20 (step 210), it may cause a transmission of an indication for a DAF setting to the mobile terminal 10 (step 211).

Since the operator x of network 20 wants to prevent mobile terminals from using free automated content, the provided indication defines that the DAF in the secure storage 12 of the mobile terminal 10 has to be set to “true”. Otherwise, no DAF related indication would have to be transmitted, or an indication that the DAF in the secure storage 12 can be set to “false”. The operator x of the network 20 might also differentiate between different mobile terminals, for instance depending on the contract of their users, and allow only some of them using free automated content.

The DRM engine 18 monitors in the meantime whether the mobile terminal 10 receives an indication for updating the DAF from the new network 20 (step 222).

If the DRM engine 18 detects an indication that the DAF has to be set to “true”, the DRM engine 18 changes the setting of the DAF in the secure storage 12 accordingly (223).

As long as no such indication is received, either because the operator of the new network does not support a DAF setting or because the operator of the new network consents using any type of content as an automated content, the DRM engine 18 does not change the setting of the DAF. Thus, the DAF remains set to “false” by default.

FIG. 3 is a flow chart illustrating the use of the DAF setting in the secure storage 12 by the mobile terminal 10.

A user of the mobile terminal 10 may try to set a content stored in the MMC 15 by means of the profiles application 16 via a user interface. A user may select for example a specific tone, for which a data file is stored, either for listening to it right away or for use as an automated content for a default ringing tone.

The DRM engine 18 is informed whenever a user tries to set any stored content (step 301).

Thereupon, the DRM engine 18 checks at first whether the selected content is to be set as an automated content (step 302). If this is not the case, for instance because a tone is simply to be played-back, the content is allowed to be used, for instance to be played with a player of the mobile terminal 10 (step 303).

If the DRM engine 18 determines in contrast that the selected content is to be used as an automated content, for instance because it is to be used for a default ringing tone, the DRM engine 18 checks further whether the selected content is DRM protected (304).

In case the selected content is determined to be DRM protected, the DRM engine 18 allows the profiles application 16 setting the content as an automated content (305). Otherwise, the DRM engine 18 checks in addition the current setting of the DAF in the secure storage 12 (step 306).

If the DAF is set to “false” in the secure storage 12, this indicates that the operator of the network to which the mobile terminal 10 is currently connected is not interested in preventing the use of non-DRM protected automated content. The DRM engine 18 thus allows the profiles application 16 setting the selected content as an automated content, even though it is not DRM protected content (step 305).

If, in contrast, the DAF is set to “true” in the secure storage 12, this indicates that the operator x of the network 20 to which the mobile terminal 10 is currently connected desires to prevent the use of non-DRM protected automated content. The DRM engine 18 does therefore not enable the profiles application 16 to set the selected content as an automated content. Instead, the DRM engine 18 causes an output via a user interface informing the user that the selected setting is not possible. This may be for example a text output on a display “Not able to set free content into default ringing tone” (step 307).

It is to be understood that the themes application 17 can be controlled in the same manner as described for the profiles application 16. Further, any other application, which enables a user to select automated content, can be controlled in the same manner as described for the profiles application 16.

It is further to be noted that the described embodiment can be varied in many ways and that it moreover constitutes only one of a variety of possible embodiments of the invention.

1. Method for controlling a use of automated content at a wireless communication terminal (10), which wireless communication terminal (10) is able to access a wireless communication network (20), said method comprising at said wireless communication network (20):
detecting a wireless communication terminal (10) accessing said wireless communication network (20); and
transmitting an indication to said wireless communication terminal (10) indicating that said wireless communication network (20) allows said wireless communication terminal (10) to use exclusively automated content which is protected by digital rights management.

2. Method according to claim 1, wherein said automated content comprises at least one of a ringing tone, a background image, a wallpaper, a skin and a theme.

3. Method according to claim 1, wherein said indication is a flag.

4. Method according to claim 1, wherein said indication indicates only for selected types of automated content that said wireless communication network (20) allows said wireless communication terminal (10) to use exclusively automated content which is protected by digital rights management.

5. Method according to claim 1, wherein said indication indicates separately for different types of automated content that said wireless communication network (20) allows said wireless communication terminal (10) to use exclusively automated content which is protected by digital rights management.

6. Method for controlling a use of automated content at a wireless communication terminal (10), which wireless communication terminal (10) is able to access a wireless communication network (20), said method comprising at said wireless communication terminal (10):
receiving from said wireless communication network (20) an indication indicating whether said wireless communication network (20) allows said wireless communication terminal (10) to use exclusively automated content which is protected by digital rights management; and
storing said indication in a storage (12).

7. Method according to claim 6, wherein said automated content comprises at least one of a ringing tone, a background image, a wallpaper, a skin and a theme.

8. Method according to claim 6, wherein said received indication comprises a flag.

9. Method according to claim 6, wherein said received indication is stored by setting a flag in said storage (12).

10. Method according to claim 6, wherein said indication indicates for selected types of automated content whether said wireless communication network (20) allows said wireless communication terminal (10) to use exclusively automated content which is protected by digital rights management.

11. Method according to claim 6, wherein said indication indicates separately for different types of automated content whether said wireless communication network (20) allows said wireless communication terminal (10) to use exclusively automated content which is protected by digital rights management.

12. Method according to claim 6, further comprising preceding steps of:
detecting that said wireless communication terminal (10) is accessing said wireless communication network (20); and
storing an indication in said storage (12) indicating that said wireless communication network (20) allows said wireless communication terminal (10) to use any kind of automated content.

13. Method according to claim 6, wherein said storage (12) is protected from unauthorized accesses.

14. Method according to claim 6, further comprising in case a user of said wireless communication terminal (10) selects a content for use as an automated content:
preventing a use of said content as an automated content, if said content is determined not to be protected by digital rights management and said indication stored in said storage (12) indicates that said wireless communication network (20) allows said wireless communication terminal (10) to use exclusively automated content which is protected by digital rights management.

15. Method according to claim 13, further comprising informing a user of said wireless communication terminal (10) in case a requested use of a selected content as an automated content is prevented.

16. Processing module (22) for a network element (21) of a wireless communication network (20), which wireless communication network (20) can be accessed by a wireless communication terminal (10), said processing module (22) being adapted to receive information that a wireless communication terminal (10) is accessing said communication network (20) and to cause a transmission of an indication to said wireless communication terminal (10) indicating that said wireless communication network (20) allows said wireless communication terminal (10) to use exclusively automated content which is protected by digital rights management.

17. Network element (21) for a wireless communication network (20) comprising a processing module (22) according to claim 16.

18. Automated content control software code for controlling a use of automated content at a wireless communication terminal (10), which wireless communication terminal (10) is able to access a wireless communication network (20), said automated content control software code realizing the following steps when running in a processing module (22) of a network element (21) of said wireless communication network (10):
detecting a wireless communication terminal (10) accessing said wireless communication network (20); and
transmitting an indication to said wireless communication terminal (10) indicating that said wireless communication network (20) allows said wireless communication terminal (10) to use exclusively automated content which is protected by digital rights management.

19. Software program product storing an automated content control software code according to claim 18.

20. Processing module (18) for a wireless communication terminal (10) which is able to access a wireless communication network (20), said processing module (18) being adapted to receive from said wireless communication network (20) an indication indicating whether said wireless communication network (20) allows said wireless communication terminal (10) to use exclusively automated content which is protected by digital rights management, and to store a received indication indicating whether said wireless communication network (20) allows said wireless communication terminal (10) to use exclusively automated content which is protected by digital rights management in a storage (12) of said wireless communication terminal (10).

21. Processing module (18) according to claim 20,
which is further adapted to receive information that a user of said wireless communication terminal (10) selects a content for use as an automated content and to determine whether said content is protected by digital rights management;
which is further adapted to retrieve an indication indicating whether said wireless communication network (20) allows said wireless communication terminal (10) to use exclusively automated content which is protected by digital rights management from said storage (18); and
which is further adapted to prevent using a content selected by a user as an automated content, if said content is determined not to be protected by digital rights management and an indication retrieved from said storage (12) indicates that said wireless communication network (20) allows said wireless communication terminal (10) to use exclusively automated content which is protected by digital rights management.

22. Wireless communication terminal (10) which is able to access a wireless communication network (20), comprising a processing module (18) according to claim 20.

23. Wireless communication terminal (10) according to claim 22, further comprising
a storage (12) adapted to store an indication indicating whether or not said wireless communication network (20) allows said wireless communication terminal (10) to use exclusively automated content which is protected by digital rights management; and
at least one application (16, 17) which is adapted to set a content as an automated content.

24. Digital rights management software code for controlling a use of automated content at a wireless communication terminal (10), which wireless communication terminal (10) is able to access a wireless communication network (20), said automated content control software code realizing the following steps when running in a processing module (22) of said wireless communication terminal (10):
receiving from said wireless communication network (20) an indication indicating whether said wireless communication network (20) allows said wireless communication terminal (10) to use exclusively automated content which is protected by digital rights management; and
storing said indication in a storage (12).

25. Software program product storing an automated content control software code according to claim 24.

26. Wireless communication system comprising at least one network element (21) according to claim 17 and at least one wireless communication terminal (10) according to claim 22.
